(19) United States
(12) Patent Application Publication
(10) Pub. No.: US 2018/0059260 A1
(43) Pub. Date: Mar. 1, 2018

(54) PRAD ZOOM LENS DESIGN FOR TILTED SCINTILLATORS

(71) Applicant: National Security Technologies, LLC, North Las Vegas, NV (US)

(72) Inventors: Robert M. Malone, White Rock, NM (US); Morris I. Kaufman, Santa Fe, NM (US); Daniel K. Frayer, Los Alamos, NM (US); Alfred Meidinger, Los Alamos, NM (US)

(21) Appl. No.: 15/686,080

(22) Filed: Aug. 24, 2017

Related U.S. Application Data
(60) Provisional application No. 62/378,810, filed on Aug. 24, 2016.

(51) Int. Cl. G01T 1/20

(52) U.S. Cl. CPC G01T 1/2002; G01T 1/2023; G01T 1/2006

(57) ABSTRACT

A system for proton radiography that includes an accelerator pipe configured to direct protons to a scintillator configured to receive the protons from the accelerator pipe and in response thereto generate light emissions which form an image. A pellicle reflects the image from the scintillator to a lens assembly having a first end and a second end. The first end is configured to receive the image from the pellicle. The lens assembly includes a movable lens group which provides a variable magnification function to provide a magnified image from the lens assembly. A housing is configured to support the lens assembly and the housing includes a movable rail on which the movable lens group moves to achieve the zoom function. A camera is arranged at the second end of the lens group and is configured to receive and record the magnified image.

### 2. PRIORITY CLAIM

This application claims priority to and the benefit of U.S. Provisional Application No. 62/378,810 filed on Aug. 24, 2016, the contents of which are incorporated by reference in its entirety herein.

### 1. STATEMENT REGARDING FEDERAL RIGHTS

This invention was made with government support under Contract No. DE-AC52-06NA25946 and was awarded by the U.S. Department of Energy, National Nuclear Security Administration. The government has certain rights in the invention.

### 3. FIELD OF THE INVENTION

This innovation relates to lens systems and in particular to a zoom lens system for tilted scintillators.

### 4. RELATED ART

It is often desired to capture image data of an event to better understand and characterize the event. The image data may be captured due to energy in the visible wavelengths or in other spectrums or energy levels, such as x-ray energy or protons.

One such system is a flash proton radiography facility^{1, 2, 3} that was developed at Los Alamos National Laboratory which utilizes an 800 MeV proton beam with variable burst widths and burst interval times (typically 60 ns pulse widths and 14 bursts). These multiple bursts permit generating radiographic “movies” of the temporal behavior of explosively driven objects with approximate areal densities between 10 mg/cm² and 30 g/cm².

Proton radiography is analogous to transmission X-ray radiography, but uses protons instead of photons. Proton radiography has high penetrating power, high detection efficiency, small-scattered background, inherent multi-pulse capability, and large standoff distances between test objects and detectors. Proton radiography can make multi-frame radiographs or radiographic movies.

The current proton radiography imaging system for dynamic experiments is based on a system of seven individual high-resolution CCD cameras, each with its own optical relay and fast shuttering. For each image within a movie, a separate camera assembly is required.

The current imaging diagnostic for proton radiography uses a fixed-magnification Nikkor 85 mm f/1.4 lens to collect light from an LYSO scintillator. Multiple camera systems viewed the same scintillator at 8° angles. There are 2 folding mirrors for each of the seven lines of sight. The size of the scintillator is 127 mm square and the image at the camera is 19 mm. To obtain best focus when imaging the scintillator from 24 inches away, spacers were added between the lens and the camera. In other embodiments, other distances may be established and space may or may not be used. Resolution varied considerably from the center to the edge of the field. This lens was not designed to focus well this close to the object, so current operation results in additional vignetting and considerable illumination roll-off at the edge of the field. No provision is made to tilt the camera to compensate for the tilted object.

While the prior system is capable of capturing image data it suffers from several drawbacks. One such drawback is that the system has a fixed magnification, preventing any effective zoom capability. In addition, it is preferred to increase resolution of the system. It suffers from illumination roll-off and degradation in performance due to inability to compensate for a tilted object. It collects inadequate light levels, limiting system dynamic range, and even its on-axis performance is insufficient to meet future experimental requirements.

### SUMMARY

To overcome the drawbacks of the prior art and to provide additional benefits, a system for optical recording of proton radiography is disclosed. In this example embodiment, an accelerator is provided and configured to direct protons to a scintillator. The scintillator is configured to receive the protons from the accelerator and in response thereto generate light emissions which form an optical image equivalent to the proton radiograph. A pellicle is configured to reflect the image from the scintillator. Also part of this embodiment is a lens assembly having a first end and a second end. The first end is configured to receive the image from the pellicle. The lens assembly includes a movable lens group which provides a variable magnification function for the lens group to provide a magnified image from the second end of the lens assembly. A housing supports the lens assembly. The housing includes a movable rail on which the movable lens group moves to achieve the zoom function. A camera is arranged at the second end of the lens group and is configured to receive and record the magnified image.

The scintillator may be a LYSO type scintillator. In one embodiment, the rail and movable lens group are controlled by a motor to remotely control an amount of variable magnification. This system may further include one or more additional lens assemblies, housings, and cameras arranged to capture the image from the pellicle. In one configuration, the camera has different alpha and beta angles associated with different optical magnifications. In one configuration, the movable lens group is a doublet. The camera may be a charge coupled device.

Also disclosed herein is a method for capturing an image representing an event. In one embodiment, this method includes receiving protons from an event from an accelerator with a scintillator, such that the scintillator converts the protons to optical emission to form an image. This method then receives the image at a pellicle and reflects the image from the pellicle to a lens assembly. The lens assembly magnifies the image within the lens assembly to create a magnified image. Magnification is varied by controlling the position of a moveable lens group that is part of the lens assembly. The magnified image is presented to a camera which records the magnified image to create image data. The image data are stored in a non-transient state in a physical memory.

In one embodiment, the scintillator is a LYSO-type scintillator. The camera may comprise a charge capture device. It is contemplated that the moveable lens group may be a doublet lens. In one variation, the step of controlling a position of a moveable lens group includes mounting the moveable lens group on a rail such that the moveable lens group is moveable along the rail, and then sending a control signal to a motor. The motor causes movement of the moveable lens group along the rail thereby changing a position of the moveable lens group in relation to other lenses in the lens assembly, which in turn adjusts magnification. In one variation, the method also establishes a tilt in the camera. The tilt may include a beta angle and alpha angle tilt.

Also disclosed is a lens assembly for use in a high-energy imaging system. This system includes a scintillator configured to generate an image formed by light emissions that represent an event and a pellicle configured to reflect the image from the scintillator to the lens assembly. The lens assembly is supported by a housing and the lens assembly is formed from two or more lens group. In this embodiment, the lens assembly includes a first lens group configured to receive the image from the pellicle and a movable lens group. The movable lens group is configured to receive the image from the first lens group. The movable lens group causes the lens assembly to change magnification. Also part of this embodiment is a third lens group and a fourth lens group. A camera is provided to receive record the image from the fourth lens group.

In one example embodiment, protons from an accelerator pipe strike the scintillator to generate the image. It is contemplated that the movable lens group is movable along a rail that supports the third lens group, such that moving the movable lens group along the rail changes magnification of the lens assembly.

This embodiment may further include a motor linked to the moveable lens group such that the motor, responsive to a control signal, is configured to change position of the movable lens group. In one embodiment, the lens assembly has a center axis and the camera is tilted in relation to the center axis. In addition, the camera has a position defining alpha and beta angles which change with the different magnification of the lens assembly.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1A illustrates an exemplary design for proton radiography system.

FIG. 1B illustrates an alternative angle for a camera and lens system.

FIG. 2 shows initial optical modeling of the zoom lens at four different magnifications for one exemplary lens embodiment.

FIG. 3 illustrates an alternative embodiment of a lens system showing the alpha mechanical tilting angle.

FIG. 4 illustrates a block diagram of an exemplary camera system.

FIG. 5 illustrates a plot of resolution across the field of view.

FIG. 6 illustrates an alternative embodiment of a lens system.

FIG. 7 illustrates an example embodiment of a lens housing.

FIG. 8 illustrates an example lens system for the proton radiography system disclosed herein with glass types to be used.

FIG. 9 illustrates an alternative embodiment having eighteen framing cameras with associated lens systems.

FIG. 10 illustrates an alternative embodiment having eighteen framing cameras with associated lens systems.

### DETAILED DESCRIPTION

To overcome the drawbacks of the prior art and provide additional advantages, a zoom lens system is disclosed. This system may find use and be beneficial in numerous different environments but is discussed herein in relation to proton radiography with a scintillator. During the design process, the inventors realized that numerous challenges were present that be met neither by the prior art system nor by commercially available systems. For example, when a zoom lens views a tilted finite conjugate object, its image plane is both tilted and distorted to an extent depending on magnification. The lens design disclosed herein moves one doublet lens change magnification. The image plane design disclosed herein has six degrees of freedom, to adjust for change in position and a tilted image plane with variable tilt angles. Several lens design models were analyzed and are disclosed herein as alternative embodiments. A first design required the optical and mechanical axes to be co-linear, resulting in a tilted stop. The second design allowed the optical axis to be tilted from the lens mechanical axis with an un-tilted stop moving along the mechanical axis. Both designs produced useful zoom lenses with excellent resolution for a distorted image. For both lens designs, the stop was anchored to the moving doublet, and its diameter unchanged throughout magnification changes.

One primary benefit of the lens system disclosed herein is that it can take images of objects that are not normal to the optical axis. This occurs by deliberately establishing the mechanical axis and optical axis non-co-linear, which improves the resolution. This is not previously disclosed in the prior art and should be noted is separate from the Shleimpflug condition. Adding to the novelty of this lens system is that it has only one moving lens group, and the stop is fixed to the moving group. Most zoom lenses have more than one group, and allowing the camera independent motion allows the design to require a single moving group. As such, the camera functions like a second lens group. The purpose of the lens is to look at tilted objects, therefore the camera is also configured to tilt. The variability required to enable the camera to change focal position and tilt enables additional benefit to performance, such as decentration and twisting.

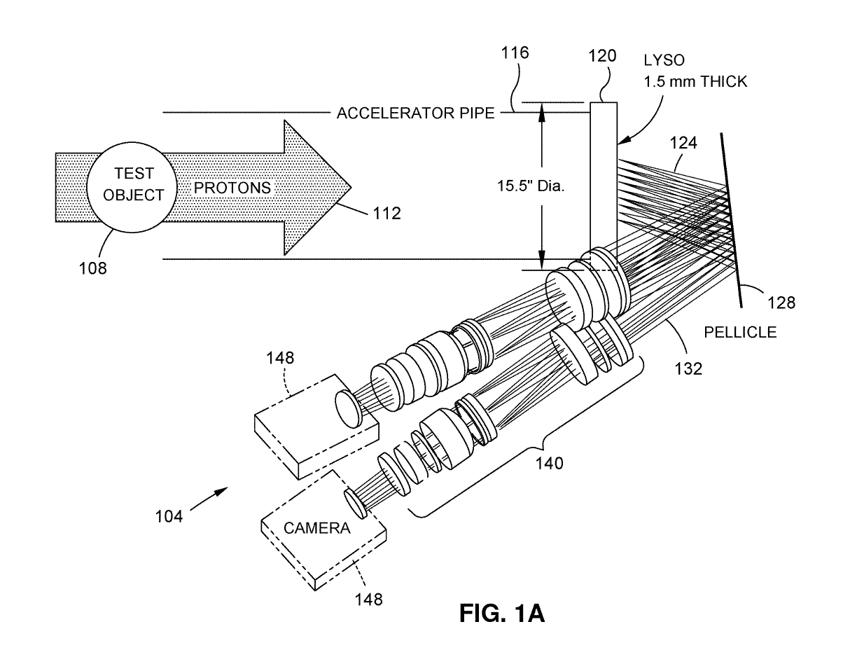

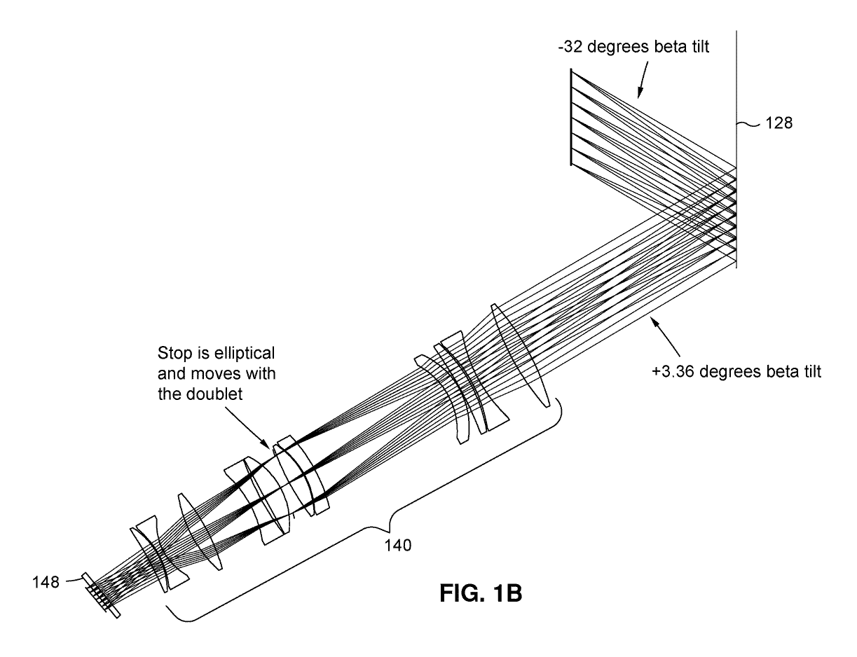

FIG. 1 illustrates an exemplary design for proton radiography system but other applications, environments and embodiments are contemplated. As shown a proton radiography system 104 is shown to detect protons from a test object 108. The test object 108 is presented at the first end of the accelerator pipe 116. Protons 112 radiate from the test object 108 and are directed and/or contained by the accelerator pipe 116. As a second end of the pipe 116, protons exit an aluminum vacuum window producing a shadowgraph image onto a LYSO (lutetium yttrium orthosilicate) scintillator 120. The scintillator generates an image in response to the proton collisions. A 5″ square scintillator emission 124 is emitted from the LYSO 120 to a pellicle 128. The emission 124 reflects off a pellicle 128 to form a reflected emission 132. The reflected emission 132 is collected by the zoom lenses 140 located, in this embodiment, 24″ away. In other embodiments, the scintillator 120 may be other than 5″ in size and shape. Likewise, in other embodiments the lenses 140 may be located at distances other than 24″. Multiple zoom lenses will view the same pellicle at different elevation and azimuthal angles. A camera 148 is configured to receive the light through the lens for recording, such as in a digital format.

The elevation (sometimes called altitude) is the angular deviation (from 0° to 90°) of the optical system axis relative to the accelerator LOS. It is assumed that the accelerator LOS is normal to the object plane (i.e. the LYSO). In one example embodiment, six lines of sight at an elevation angle of 20° surrounded by twelve lines of sight at an elevation angle of 38° are used. The azimuthal angle (from 0° to 360°) locates the optical axis with respect to vertical. The pellicle directs the light backwards to a zone where adequate shielding of the cameras can be achieved against radiation scattered from the aluminum window. The initial un-tilted zoom lens prototype will look on axis at a target.

Because the final version of this lens will be looking at an object (the LYSO) that is tilted with respect to its optical axis, the CCD (camera) is preferred to be tilted with respect to the optical axis as well. Because of longitudinal magnification, the orientation of the CCD will also depend on the zoom position. In addition, the tilting of the optical system may introduce a keystone distortion that is dependent on zoom position. The distortion can be removed through software, but the software correction will need to reference zoom position, elevation angle, and azimuthal angle. The CCD is also configured, in one or more embodiments, for twisting and locational adjustment to account for hardware mounting tolerances.

Although only two zoom lens systems 140 are shown, in one embodiment, four or more zoom lenses 140 are provided and configured to view the same pellicle 128 at different alpha and beta angles. In this embodiment, blue emission from the scintillator 120 is viewed at an alpha angle of −14° or −23° and beta angles of ±9° or ±25°. The pellicle 128 directs the light 132 backwards to a zone where adequate shielding of the cameras 148 can be achieved against radiation scattered from the aluminum window at the end of the accelerator pipe 116.

As a further design feature of the one or more embodiments disclosed herein, functionality is provided to allow for image zooming and steering under remote control. It was realized during design that to properly view a tilted object, the camera (or lens element(s) should likewise tilt. It was further realized that the amount of tilt depends on the zoom magnification.

In one embodiment, a cluster of the framing cameras is used to make movies, and the different cameras may view the same scintillator at different angles and at different magnifications to further enhance the proton radiography system disclosed herein. A new 3-frame camera has been tested and a newer 10-frame camera is under development.

As to resolution, prior art resolution of the proton beam 112 is 200 μm at the scintillator 120. The resolution of the optical system is limited by the resolution of the proton beam. The measured resolution of the entire current imaging system with protons is about 2.5 lp/mm with 50% modulation in the scintillator plane. The resolution of the proton beam together with the magnification places a restriction on the sensor pixel size. The current 3-frame camera⁴ has an 18.5 mm×19.2 mm sensor with 720×720 pixels, each pixel being approximately 0.026 mm. The magnification is therefore 6.7 (i.e. 127/19) bringing the needed image resolution to 16.8 lp/mm at the CCD and thus the pixels must therefore be less than 0.03 mm (i.e. 0.5/16.8). Thus, the pixel size is adequate for the current usage. Future upgrades to the magnetic focusing of the proton beam will provide 60 μm resolutions at the scintillator plane. The zoom lens system is configured to match this resolution.

In one example embodiment, the system provides a 127-mm scintillator with optimal mapping of the scintillator to the imager, with the ability to resolve a 60-μm spot at the scintillator. In addition, additional improvements are made over the prior art system. One such improvement is better shielding for radiation sensitive cameras.

Remote zoom, focus, and calibration capability in less than 2 hours is contemplated and a variety of image sensor sizes will be used in the future. Due to the thermal environment of proton radiography campaigns, the zoom lens system can operate at least from 60 to 95 degrees Fahrenheit. As disclosed below in greater detail, a tilted image plane as shown in FIG. 1 may require mechanical decoupling of the camera from the lens housing and alignment of the camera to the lens through a third component of the system. In the embodiment disclosed herein, the field of view of the LYSO scintillator varies from 127 mm to 60 mm diameter. To compare images recorded at different magnifications, scintillator mapping errors are preferred to be better than one pixel on the image sensor given current processing protocols. A factor of 2.5× more light is desired over the prior art fixed lens collection system. In one embodiment, a cluster of four zoom lens systems fit closely together in the space available under and about the proton beam line in order to minimize distortions. In one configuration, the zoom lens housing is less than 600 mm long, but in other embodiment, the length may be equal to or exceed 600 nm.

### 4. ZOOM LENS DESIGN

Returning to FIG. 1, the 4-camera system 148, 140 (only two cameras shown) wraps around the proton accelerator pipe 116. There are 2 sets of zoom lens systems at 2 different elevations. In one embodiment, the camera window is tilted differently from the zoom lens 140 axis, typically down the center of the lens system. The camera 140 may be configured with its own tilting platform to properly locate and hold the image plane. The pellicle 128 could be replaced by a large mirror or other reflective surface. The camera positions are upstream from the end of the proton accelerator pipe. Most of the background radiation scatter from the proton beam is in the forward direction and placing the cameras in this location reduced interference from radiation scatter. Cameras at these upstream locations will see minimum star blemishes from scattered radiation.

Consider a global coordinate system where the global Z is defined by the accelerator line-of-sight, and the global Y is vertical. By convention, global coordinates will be capitalized. It is convenient to define a coordinate system that is local to the lens. The local z-axis always coincides with the optical axis and points toward the imaging sensor. Local axes will be shown in lower case. The local z axis is rotated by the elevation angles of 20° and 38° with respect to global Z. The local x and y axes are defined by orthogonality and the right-hand rule. For our purposes, the local z is rotated to the elevation angle. Furthermore, we clock the local x axis azimuthally in increments of 60° for the inner group of 6 lenses, and by 30° for the outer group of twelve lenses. Alpha and beta angles are defined as rotations about the local y and x axes respectively. The gamma angle is twisting about the local z-axis and is related to image rotation. Alpha rotations of the object or image will be visible x-z plane and beta rotations will be visible in the y-z plane.

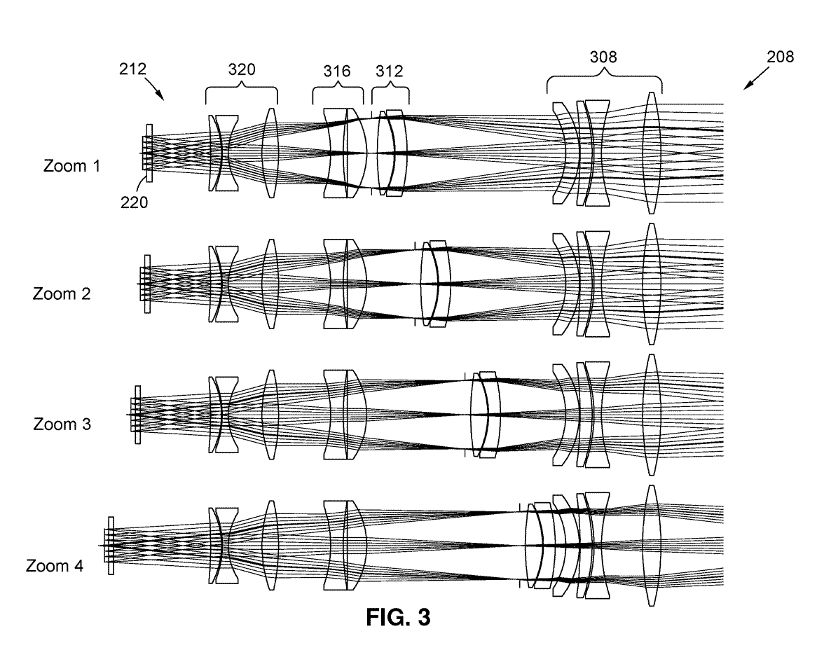

In this configuration, the LYSO 120 emits light with a numerical aperture of greater than 0.56 and, as a result, collecting images at tilted angles is not an issue. In FIG. 3, the alpha angle (up and down in the plane of the page) is 14 degrees for the upper pair of zoom lenses, and 23 degrees for the lower pair of zoom lenses. The beta angle (in and out of the page) is 25 degrees for the upper pair of zoom lenses, and 9 degrees for the lower pair of zoom lenses. The resolution loss for a zoom lens placement scales with the maximum value of either the alpha or beta angle and as such, the performance of the upper pair of zoom lenses is slightly worse than the lower pair of zoom lenses.

Optical modeling was performed for 4 different zoom magnifications for each of the 4 imaging systems. FIG. 1 shows only one zoom position for two camera/lens systems 140, 148 which is the full field view. This side view shown in FIG. 1 hides two of the zoom lens systems 140 to avoid confusion and overlapping structure. The actual tilt (alpha & beta) of each camera 148 will depend on its zoom magnification.

FIG. 1B illustrates an alternative angle for a camera and lens system. As compared to FIG. 1A, identical elements are labeled with identical reference numbers. This embodiment illustrates a −32-degree beta tilt prior to the pellicle and a +3.36-degree beta tilt after the pellicle. Other embodiments may be configured with different tilt angles.

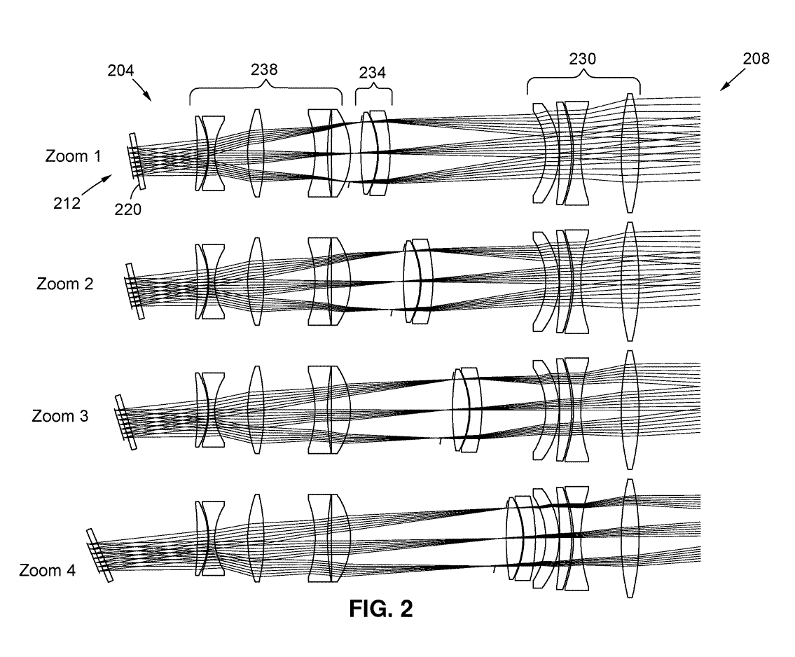

FIG. 2 shows initial optical modeling of the zoom lens at four different magnifications for one exemplary lens embodiment. Light enters the lens system 204 at a first end 208 and exits at a second end 212 to be received by a camera, such as a CCD 220. The lens systems 204 is formed from three lens groups, the receiving lens group 230, the moving lens group 234, which control zoom function, and the output lens group 238. In this embodiment, the circular stop tilt will change as shown for each zoom position. Because the LYSO scintillator is viewed from compound tilted angles, this zoom lens design required the stop to be tilted at compound angles (both alpha and beta). In this embodiment, limited performance was obtained. Light collection was improved by three-fold but, challenges exist obtaining the 60 μm resolution goal.

In the embodiment of FIG. 2, clearance distance between the zoom lens 238 and the camera 220 was maximized in the design, so that if a smaller diameter CCD camera is used, then a doublet could be inserted into this air gap to change the magnification range. Several types and sizes of CCD cameras are envisioned for future use the zoom lens.

To improve on the resolution, the zoom lens was allowed to tilt relative to the optical axis which resulted in improved resolution. The alpha mechanical tilting angle can be seen in FIG. 3, which illustrates an alternative embodiment of a lens system. In this ray trace perspective, light enters the first end 208 of the first lens element 208 (left side) and exits at the bottom of the second end 212 of the final lens element 320. Also part of the lens system is a movable lens element 312 that enables the zoom function, and an additional lens group 316. In one embodiment, the stop is normal to the lens mechanical axis. The stop has 0-degree alpha tilt for all zoom positions and moves with the doublet. In this embodiment, the resolution is much improved to about 35 μm in all magnifications, and at all lens positions surrounding the accelerator pipe. The 35 μm resolution is better than what the 10-frame camera can achieve, since it can only resolve 1 part in 1100 across its image. The framing camera is tilted at 2 angles, decentered in both X and Y, and has a gamma rotation. Although in other embodiments other angles and decentering parameters are considered. These decenter and gamma rotations center the distorted image onto the framing camera image plane.

Magnification changes are accomplished with the movement of only one doublet 312 as well as movement of the framing camera 220. The stop 340 is circular and is secured to the moving doublet. There is air space between the zoom lens 320 and the framing camera housing 220, allowing adequate room for camera tilt adjustments.

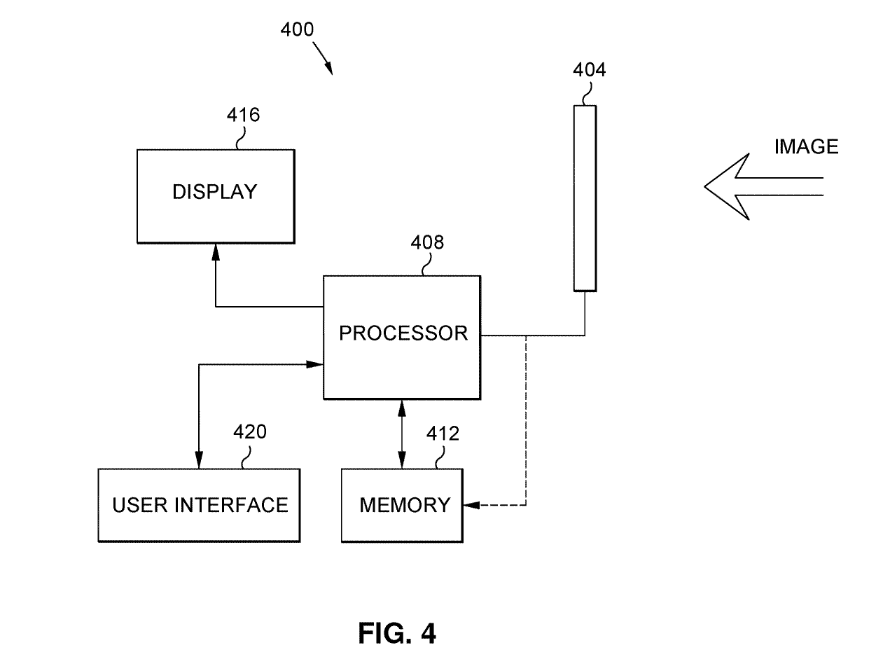

FIG. 4 illustrates a block diagram of an exemplary camera system 400. This is but one possible embodiment of a camera system. As shown, the image sensor 404, such as a charge coupled device (CCD) receives an image comprising light energy. It converts the light energy to an electrical signal which is provided to a processor 408. The image data may optionally be provided to a memory 412 which stores the image data. The processor 408 may also or alternatively offload the data to the memory 412. Also shown in FIG. 4 is a user interface 420, to receive control input from a user, and a display 416 that is configured to display the image or data regarding the image.

In operation, the image sensor 404 captures the image reflected from the pellicle. The image is recorded by the processor 408 and memory 412 in a digital format. The user interface 420 and the display 416 allows a user to view the image and interact with the image and image sensor 404. The operation of the system shown in FIG. 4 is known by one of ordinary skill in the art and as such it is not described in detail herein.

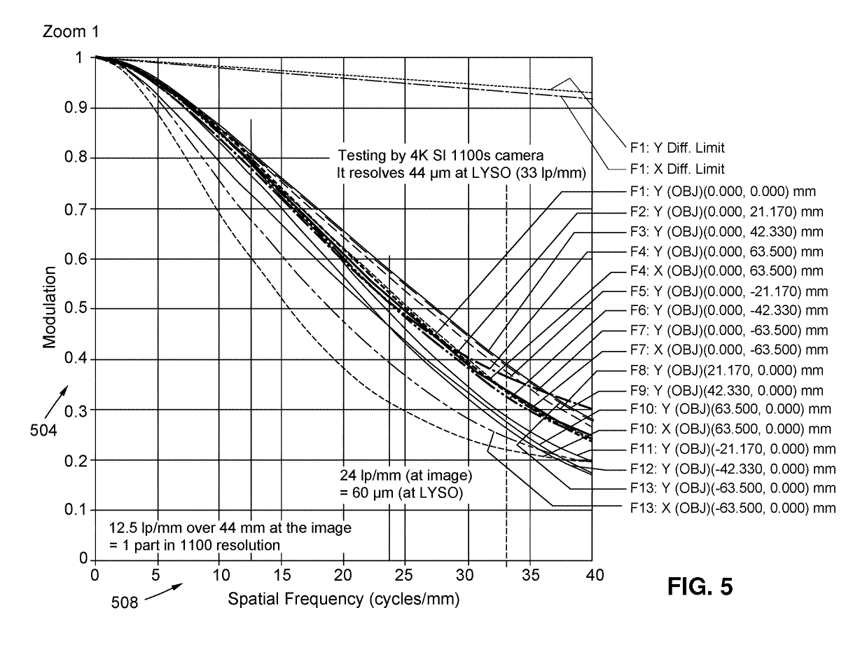

FIG. 5 modulation transfer functions (MTF) at the CCD location for a variety of field positions assuming a 3-frame camera that is looking at the full 127 mm scintillator at an 8° tilt angle with the Nikkor lens. In FIG. 5, the vertical axis 504 is modulation and the horizontal axis 508 is spatial frequency in cycles/mm. As can be seen in the plots, resolution is excellent across the field of view. This improved resolution can be compared to FIG. 3 lens system where the camera was not tilted to compensate for viewing a tilted object. The plot shows that the image resolution is 20 lp/mm on axis, but only 7 lp/mm at the edge of the sensor for 50% modulation. The current system has adequate resolution on axis but resolution decreases (from a resolution point of view) at the edge of the sensor. The resolution can be improved by making the iris smaller (and increasing the f-number), but the cost is lower light throughput. Shown in FIG. 5 is the MTF for the maximum field of view and at the highest values of both the alpha and beta angles (worse case). The resolution loss will increase as this maximum tilt angle is increased. The zoom lens was tested with a Scientific Instruments SI 1100s camera, which is a 4K pixel CCD camera that has an imager measuring 62×62 mm.

There is distortion in the image because of the alpha and beta tilting and the amount of distortion depends on the alpha and beta tilts. The amount of distortion is different at each lens position and at each magnification but overall good resolution is achieved and image processing can easily map out the distortion through corrections.

### Extending Magnification of Zoom Lens

In one embodiment or configuration, a variety of different camera image sizes are configured for use with the lens system. This allows a wide variety of framing cameras to be used as image requirements and technology evolves. The current zoom lens design disclosed herein is configured to be upgradeable with other future image sizes. For this design, considerable additional back focus distance was provided between the lens and the large format CCD to accommodate different camera systems and sizes. For example, if a smaller CCD size is used, this distance will shrink depending on the magnification requirement.

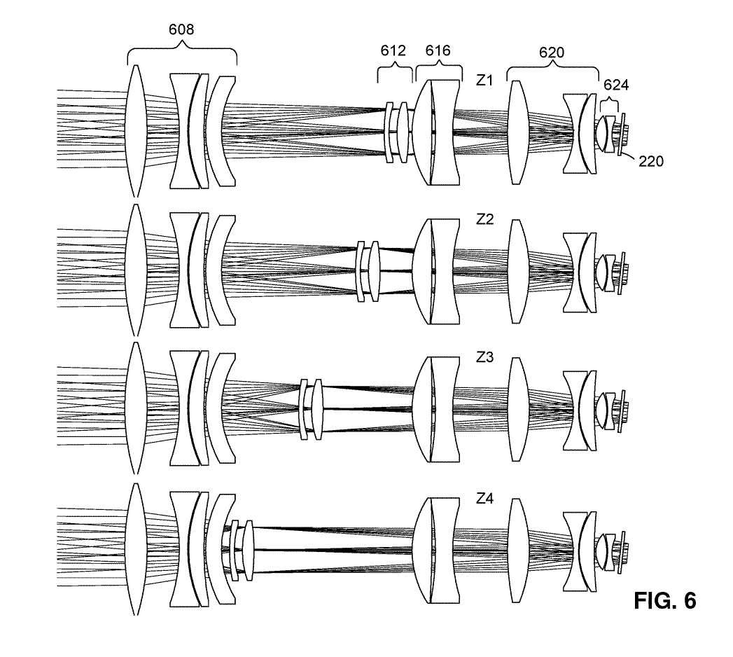

An alternative embodiment of the lens system is shown in FIG. 6. As shown, a doublet lens 624 is inserted between the lens group 620 and the CCD 220. Also part of this alternative embodiment are lens groups 608 configured to receive the light from the source, a movable lens group 612 that controls the zoom magnification, and a fixed lens group 620 near the doublet lens 624. Magnification reduction was achieved. However, the resolution could only be improved by also swapping out the moving doublet with another lens assembly. The 3-frame imager is 18.7 mm square. In the embodiment of FIG. 6, less light is collected due to the modified zoom lens, however, the intensity of the light at the image capture device is preserved because it is more concentrated.

### Optomechanical Considerations

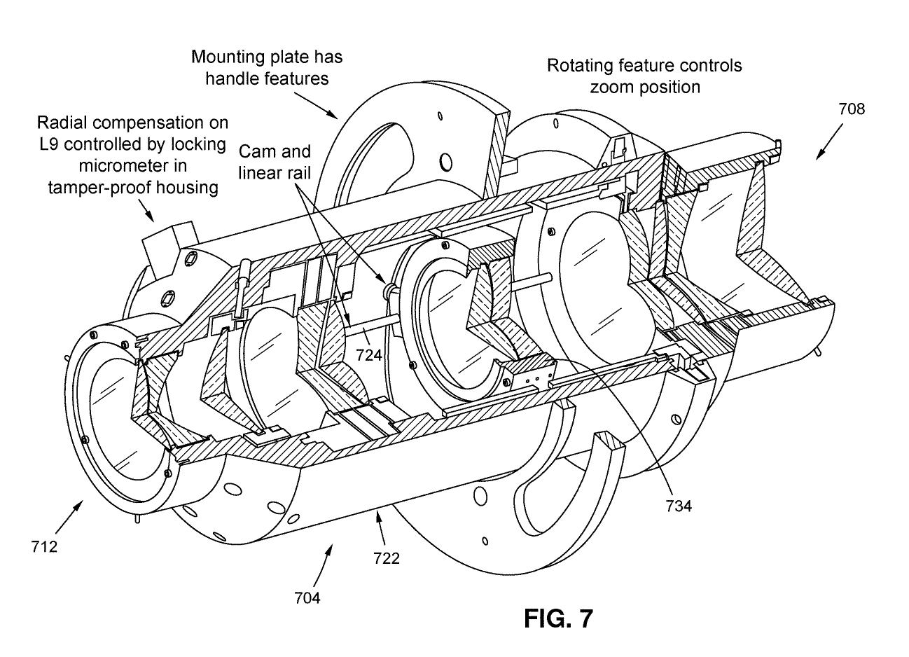

FIG. 7 illustrates an example embodiment of a lens housing. The housing is circular to minimize its footprint and configured to hold the lens described above. This is but one possible embodiment and other configurations are possible. In this example embodiment, a light receiving end 708 is opposite a light output end 712 of the housing 704. Connected to and as part of the housing are several lenses supports. The lens support 734 holds and supports the moving lenses that control the zoom function. Along the bottom of the housing is a platform 722 configured to secure the housing to a platform or other mounting surface. Along the bottom of the platform are rails 724 and a motor and encoder that allows for motor driven movement of the movable lens in the lens support 734. Use of the motor and encoder allows remote control operation of the lens system from a location away from the proton accelerator. In other embodiments, other systems and designs may be provided to achieve remote (wired or wireless) controlled movement of one or more lenses in the housing.

Bore sight errors typically control the drives the optical tolerance and accuracy. The MTF (modulation transfer function) resolution requirement is different for each zoom magnification. The full field of view (127 mm) was evaluated at 30 Ip/mm, while the ⅔ field of view was evaluated at 26 Ip/mm, and ⅓ field of view was evaluated at 22 lp/mm. A minimum field of view (60 mm) was evaluated at 18 lp/mm. In one embodiment, the decenter of 50 μm was used for the assembly of this zoom system.

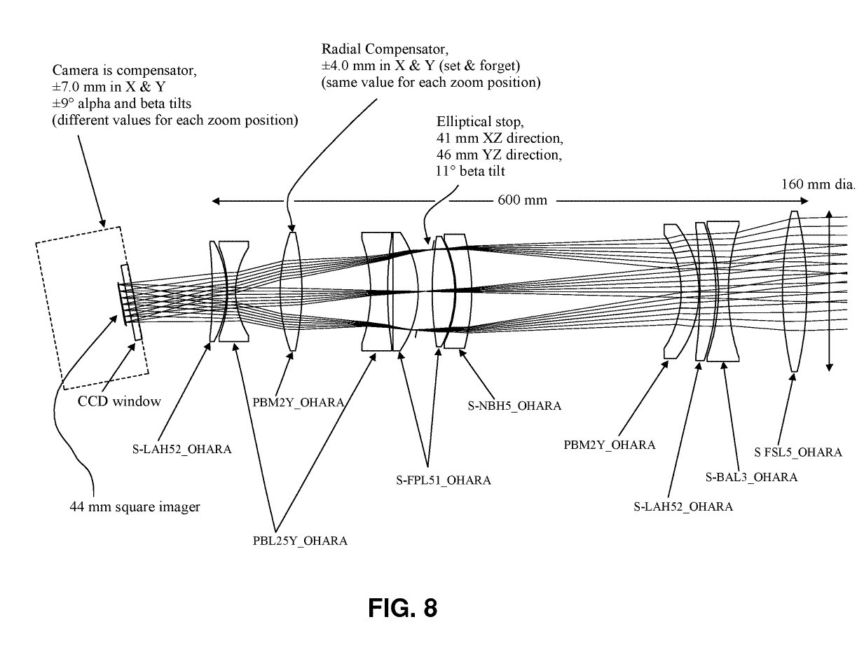

In one or more embodiments, the glass elements were selected to maximize transmission at blue wavelengths. However, in other embodiments other wavelengths may be selected for peak wavelength transmission. The peak emission of LYSO is typically at 435 nm. FIG. 8 illustrates an example lens system for the proton radiography system disclosed herein with glass types to be used. This is but one possible example embodiment and in other embodiments other types of glass may be used. One lens has been chosen as a radial compensator. The tilt and decenter of the camera is also a critical compensator. Again, the optical and the mechanical axis of the zoom lens are not the same. One of ordinary skill in the art understands these glass types as shown in FIG. 8 and as such each is not described in detail.

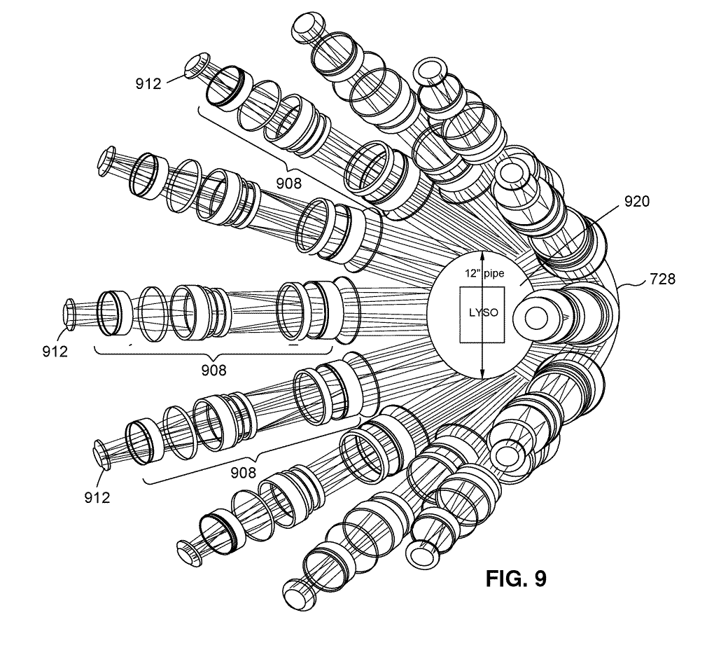

Numerous additional alternative embodiments are contemplated. One such alternative embodiment that is contemplated has an expanded number of lens and camera assemblies. This arrangement extends the scintillator at angles or shapes to maximize the number of zoom lenses that would flow around the proton accelerator pipe. By setting each viewing angle to 32 degrees, twelve zoom lens systems can be envisioned, as shown in FIG. 9. As shown, lens systems 908 are paired with cameras (CCD) 912 or other imaging system. The lenses receive light from the LYSO 920 as shown after reflection from the pellicle 728. Resolution loss is increased slightly with this higher viewing angle. The previous MTF curve from FIG. 5 had a maximum alpha or beta angle of 25 degrees. The last two lenses have their diameters increased from 98 to 104 mm, due to the light angle exiting the zoom lens having also been increased. Total distance from the LYSO 920 to first lens surface is unchanged at 24 inches but could be other distances. When the system zooms in to the 60 mm diameter field of view and the lenses 908 move this smaller field of view to different quadrants of the LYSO 920, the front surface of the zoom lens may ideally be the zoom lens pivot in order to prevent lens crashing. Each zoom lens system 908 and each framing camera 912 will have to have their own tilt and decentering platforms (not shown).

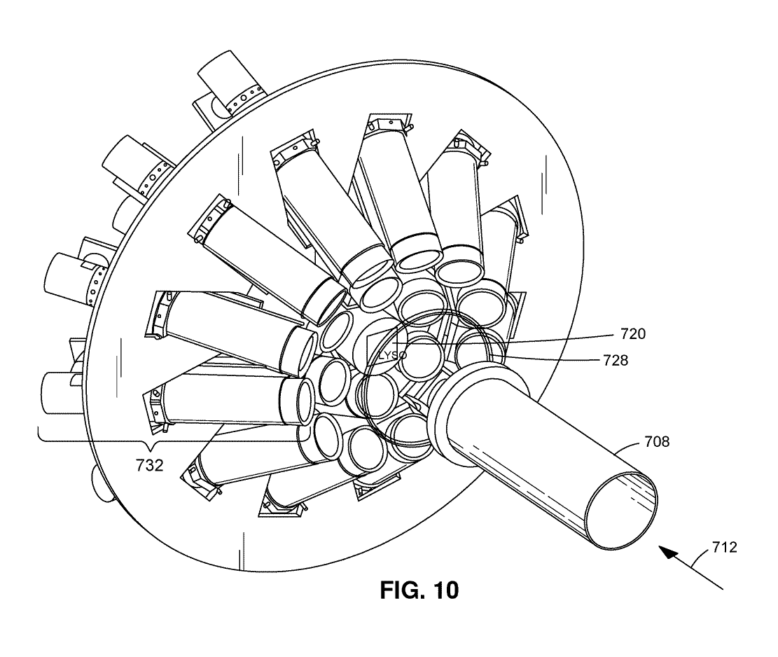

FIG. 10 illustrates an alternative embodiment having eighteen framing cameras with associated lens systems. As shown, the accelerator pipe 708 receives a proton stream 712 from a source or event. The proton strike a LYSO 720 which emits light. The inner ring 728 collects light at 20 degrees to the LYSO. Lenses 732 are arranged as shown to collect and deliver light to a camera system or CCD (not shown). The outer ring collects light at 38 degrees. Angular light distribution emitted by the LYSO 720 at 38 degrees will be reduced. The end of the accelerator pipe 708 may be reduced in diameter from 12 inches to about 9 inches. Operating just two of these 10-frame zoom lens systems will improve on prior art proton radiography recording systems.

A better optical design has the unusual property of the zoom lens mechanical axis tilted relative to the optical axis. The new zoom lens design provides new capability for proton radiography. Light collection is improved by more than a factor of three. In addition, the new design provides greater than a factor of three improvements in resolution. This optical system resolution is better than any potential proton radiographic resolution upgrades that could occur in the future. An unusual feature of this zoom lens design is that as you zoom to smaller areas of the scintillator, the light levels at the camera do not change.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

What is claimed is:

1. A system for proton radiography comprising:
an accelerator pipe configured to direct protons;
scintillator configured to receive the protons from the accelerator pipe and in response thereto generate light emissions which form an image;
a pellicle configured to reflect the image from the scintillator;
a lens assembly having a first end and a second end, the first end configured to receive the image from the pellicle, the lens assembly including a movable lens group which provides a variable magnification function for the lens group to provide a magnified image from the lens assembly;
a housing configured to support the lens assembly, the housing including a movable rail on which the movable lens group moves to achieve the zoom function; and
a camera arranged at the second end of the lens group configured to receive and record the magnified image.

2. The system of claim 1, wherein the scintillator is a LYSO type scintillator.

3. The system of claim 1, wherein the rail and movable lens group are controlled by a motor to remotely control an amount of variable magnification.

4. The system of claim 1, further comprising one or more additional lens assemblies, housings, and cameras arranged to capture the image from the pellicle.

5. The system of claim 1, wherein the camera has different alpha and beta angles associated with different magnification levels.

6. The system of claim 1, wherein the movable lens group is a doublet.

7. The system of claim 1, wherein the camera is a charge coupled device.

8. A method for capturing an image representing an event comprising:
receiving protons from an event from an accelerator pipe at a scintillator, the scintillator converting the protons to light emissions which form an image;
receiving the image at a pellicle;
reflecting the image from the pellicle to a lens assemble;
magnifying the image within the lens assembly to create a magnified image;
controlling an amount of magnification by controlling a position of a moveable lens group that is part of the lens assembly;
presenting the magnified image to a camera;
recording the magnified image with the camera to create image data; and
storing the image data on a non-transient memory.

9. The method of claim 1, wherein the scintillator is a LYSO type scintillator.

10. The method of claim 1, wherein the camera comprises a charge capture device.

11. The method of claim 1, wherein the moveable lens group is a doublet lens.

12. The method of claim 1, wherein controlling a position of a moveable lense group comprises:
mounting the moveable lens group on a rail such that the moveable lens group is moveable along the rail;
sending a control signal to a motor, the motor causing movement of the moveable lens group along the rail thereby changing a position of the moveable lens group in relation to other lenses in the lens assembly.

13. The method of claim 1, further comprising establishing a tilt in the camera.

14. The method of claim 13, wherein the tilt includes a beta angle and alpha angle tilt.

15. A lens assembly for using in high energy imaging system comprising;
a scintillator configured to generate an image formed by light emissions that represent an event;
a pellicle configured to reflect the image from the scintillator to the lens assembly;
a housing configured to support the lens assembly;
the lens assembly comprising;
a first lens group configured to receive the image from the pellicle;
a movable lens group configured to receive the image from the first lens group, the movable lens group causing the lens assembly to change magnification responsive to movement of the movable lens group;
a third lens group;
a fourth lens group configured to output the image;
a camera configured to receive record the image from the fourth lens group.

16. The assembly of claim 15 wherein protons from an accelerator pipe strike the scintillator to generate the image.

17. The assembly of claim 15 wherein the movable lens group is movable along a rail that supports the third lens group, such that moving the movable lens group along the rail changes magnification of the lens assembly.

18. The assembly of claim 17 further comprising a motor linked to the moveable lens group such that the motor, responsive to a control signal, is configured to change position of the movable lens group.

19. The assembly of claim 15 wherein the lens assembly has a center axis and camera is tilted in relation to the center axis.

20. The assembly of claim 15 wherein the camera has a position defining alpha and beta angles and the alpha and beta angles change with different magnification of the lens assembly.
